(19) United States
(12) Patent Application Publication
(10) Pub. No.: US 2009/0113022 A1
(43) Pub. Date: Apr. 30, 2009

(54) FACILITATING MUSIC COLLABORATIONS AMONG REMOTE MUSICIANS

(75) Inventors: Michael L. Quoc, San Francisco, CA (US); Scott Gatz, San Francisco, CA (US); Matthew Fukuda, San Francisco, CA (US); Eric Fixler, Oakland, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 11/923,367

(22) Filed: Oct. 24, 2007

(51) Int. Cl. G06F 15/16

(52) U.S. Cl. 709/218

(57) ABSTRACT

Disclosed are apparatus and methods for facilitating music collaboration between remote musicians (or the like) are provided. In general, mechanisms for facilitating live music collaborations or “jam sessions” over a computer network. These mechanisms allow musicians to perform from remote locations via one or more computer networks. Each musician is able to receive live video feeds from each of the other musicians during such jam session. Other computer users may form members of an audience who also receive such live video feeds from the musicians participating in the live jam session. The audience members may also receive a mixed audio feed of the audio streams from all of the participating musicians. Various features for enhancing such live jam session are described further herein.

### BACKGROUND OF THE INVENTION

The present invention relates to techniques for facilitating a musical or performance-based collaboration, especially between musicians or other types of performers who are located remotely with respect to teach other.

A group of musicians may gather together in a physical location in order to perform together and practice for any number of purposes. By way of examples, musicians in a band may wish to be prepared for an impending performance in front of an audience or for participation in a recording session. Musicians who have never performed together may also gather together to evaluate one another and determine whether they wish to play together in the future and/or form a band.

A band is typically formed so that it includes musicians with similar music style and complementary skills. A typical first step in forming a new band may include informing musicians by word-of-mouth, advertising in print and/or electronic media, etc., that a band is forming or accepting new members. Musicians then generally tryout for membership in such band by meeting and playing for the band leader or current band members. Quite often, it takes a significant amount of time to form a band (or add members to an existing band) using conventional communication channels and multiple tryout sessions with multiple potential band members.

Even after a band is formed, it is often difficult for band members to meet and play together due to various factors. For instance, the frequency of such music sessions often depends on the initiative of individual band members contacting each band member to schedule one or more “jam sessions.” Additionally, if the band members reside geographically far from each other, a jam session may be especially difficult to schedule.

In light of the forgoing, improved ways for facilitating jam sessions between musicians, or other types of performers, would be beneficial so that musicians could easily perform together, even if the musicians are located remotely to each other.

### SUMMARY OF THE INVENTION

Accordingly, apparatus and methods for facilitating music collaboration between remote musicians (or the like) are provided. In general, mechanisms for facilitating live music collaborations or “jam sessions” over a computer network are provided. These mechanisms allow musicians to perform from remote locations via one or more computer networks. Each musician is able to receive live video feeds from each of the other musicians during such jam session. Other computer users may form members of an audience who also receive such live video feeds from the musicians participating in the live jam session. The audience members may also receive a mixed audio feed of the audio streams from all of the participating musicians. Various features for enhancing such live jam session are described further herein.

In one embodiment, a method of facilitating remote collaboration between a plurality musicians over a computer network is disclosed. When a request to create a new music collaboration session is received from a first musician, information that includes a specification as to a required number and type of instruments that are needed for the new music collaboration session are obtained and one or more interface(s) for becoming a session member of the new music collaboration session are made available to each of one or more other musicians who are remotely located with respect to each other and the first musician. After enough musicians have become session members of the new music collaboration session, via their respective interfaces, so as to meet the required number and type of musicians, the execution of the new musical collaboration session is facilitated so that the session members can perform music together over the computer network.

In a specific implementation, each time a request to become a member of the new music collaboration session is received from another musician and until the new music collaboration session includes enough session members to meet the required number and type of musicians, the other musician is allowed to become a member of the new music collaboration session if the other musician is permitted to join the new music collaboration session. In one aspect, the other musician is permitted to join the new music collaboration session if the first musician gives permission for the other musician to become a member.

In another specific implementation, the one or more interface(s) for becoming a member of the new music collaboration session, that are made available to each of the plurality of musicians, includes a searchable list of lobbies for forming live music jam sessions, which include a lobby for the new music collaboration session. When a second musician selects the lobby for the new music collaboration session, the lobby for the new music collaboration session is presented to the second musician. This presented lobby includes (i) a lobby chat window for the second musician to chat with the first musician and other musicians who have also selected the lobby for the new music collaboration, (ii) information from each musician who has also selected the lobby for the new music collaboration, (iii) the specification of the required number and type of musicians that are needed for the new music collaboration session. A lobby for the new music collaboration session is also presented to the first musician, wherein such lobby includes (i) a lobby chat window for the first musician to chat with the second musician and other musicians who have also selected the lobby for the new music collaboration, (ii) information from each musician who has also selected the lobby for the new music collaboration, and (iii) an input mechanism for allowing the first musician to select one or more musician(s) from the second musician and other musicians, who have also selected the lobby for the new music collaboration, to become members of the new music collaboration. In a further aspect, the information from each musician includes a live window that can be selected to provide a live or archived audio and/or video feed from such each musician.

In an alternative embodiment, facilitating the execution of the new musical collaboration session is accomplished by presenting a session interface to each session member of the new musical collaboration session, wherein the session interface includes a plurality of video windows for streaming live video from the other session members. In a further aspect, facilitating the execution of the new music collaboration session is further accomplished by (i) receiving an audio stream from each session member; (ii) mixing the received audio streams from each session member; (iii) sending the mixed audio streams to a plurality of audience members that have requested to view the new musical collaboration session; and (iv) presenting a session interface to each audience member that includes a plurality of video windows from streaming live video from each session member. In a further aspect, this facilitation includes adjusting an input level of each received audio stream so as to substantially match the input levels of the received audio streams and synchronizing the received audio streams. In yet a further aspect, synchronizing the received audio streams in accomplished by providing a same metronome audio and/or visual count to each session member.

In yet another implementation, facilitation of the session includes (a) receiving a rating for the new musical collaboration session from each audience member; (b) presenting an average rating, based on the rating from each audience member, in each session interface that is presented to each session and audience member; and (c) archiving the new music collaboration session and the rating in a database that is accessible by one or more users. In a further aspect, multiple ratings are received for a plurality of time segments of the new music collaboration session and an average rating is determined and archived for each time segment.

In another embodiment, the invention pertains to an apparatus comprising a processor and memory. The processor and memory are configured for performing one or more of the above described operations. In another embodiment, the invention pertains to at least one computer readable storage medium having computer program instructions stored thereon that are arranged to perform one or more of the above described operations.

These and other features of the present invention will be presented in more detail in the following specification of the invention and the accompanying figures which illustrate by way of example the principles of the invention.

### BRIEF DESCRIPTION OF THE DRAWINGS

FIG. 1 is a diagrammatic representation of a network segment in which techniques of the present invention may be implemented in accordance with one embodiment of the present invention.

FIG. 2A is a diagrammatic representation of an example graphical user interface for presenting jam session creation and viewing options in accordance with one embodiment of the present invention.

FIG. 2B is a diagrammatic illustration of an interface for creating a new jam session in accordance with one implementation of the present invention.

FIG. 2C is a diagrammatic representation of a lobby interface for allowing one or more users to join a particular jam session in accordance with one embodiment of the present invention.

FIG. 3 illustrates flowcharts for creating a jam session in accordance with one embodiment of the present invention.

FIG. 4 represents an example interface for facilitating a live jam session in accordance with one embodiment of the present invention.

FIG. 5 is a procedure for facilitating a live jam session in accordance with one embodiment of the present invention.

FIG. 6 is a simplified diagram of a network environment in which specific embodiments of the present invention may be implemented.

FIG. 7 illustrates an example computer system in which specific embodiments of the present invention may be implemented.

FIG. 8 is a diagrammatic representation of the latency and/or delays that may be present within a network of remote jam members.

### DETAILED DESCRIPTION OF THE SPECIFIC EMBODIMENTS

Reference will now be made in detail to a specific embodiment of the invention. An example of this embodiment is illustrated in the accompanying drawings. While the invention will be described in conjunction with this specific embodiment, it will be understood that it is not intended to limit the invention to one embodiment. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

In general, embodiments of the present invention facilitate substantially live audio and video interactions between remote performers, such as musicians performing in a live jam session. The performers can perform together remotely over one or more computer networks by using audio and video input at their remote locations to contribute to the live jam session. In a specific implementation, the performers of a particular jam session all contribute their audio, which are then combined into a mixed audio that are output substantially in real time to the musicians (if latency is low) and to remote audience members. A video stream from each jam session member can also be output to each audience and jam session member. Accordingly, each audience member can experience the full audio and visual effect of the jam session between remote musicians. The musicians can also experience the jam session if streaming speeds are high enough to not cause audibly noticeable delays for each musician. Nevertheless, each musician can view video streams from each of the musicians while he or she participates in the live jam session.

A detailed implementation for facilitating remote jam sessions will now be described. Although the following techniques and systems of the present invention are described in relation to setting up and managing live jam sessions between musicians, of course, similar techniques and systems may be applied to any suitable type of live audio and/or video interaction between performers. By way of examples, the techniques and apparatus of the present invention may operate to facilitate audio and/or video interaction between people who are performing in talk shows, as disk jockies (DJ's), in celebrity entertainment shows, comedy performances, monologues, dance performances, etc.

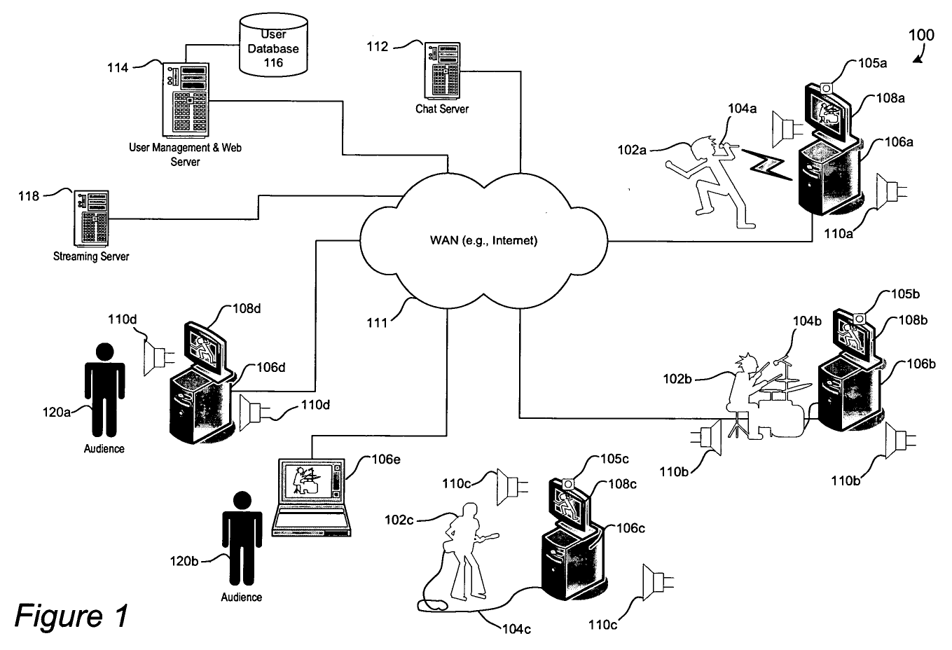

FIG. 1 is a diagrammatic representation of a network segment 100 in which techniques of the present invention may be implemented in accordance with one embodiment of the present invention. In this example, a plurality of musicians 102 can play together remotely. As shown, a singer 102a sings into a microphone 104a coupled to a computer system 106a; guitarist 102c plays so that the guitar audio is received via input cable 104c into an audio input of computer system 106c; and drummer 102b plays her drums so that the drum audio is input into computer system 106b. Live video of the musicians 102 are also captured by their respective cameras 105. As each musician performs, a video stream may also be input, e.g., via web cameras 105, to their respective computer systems.

Audio and video may then be streamed into each musician's computer system and over one or more networks, such as wide area network (WAN) or Internet 111 to one or more servers. One or more servers or computer devices may be utilized for facilitating a substantially live jam session so that audio and/or video streams may be presented to one or more people, e.g., audience or musicians, via their respective computer systems. In the illustrated implementation, a streaming server 118 may be configured to receive the audio and video streams from each of the musicians in a particular live jam session. That is, the streaming server 118 receives video streams from each web camera 105 (or any other suitable type of video input device) and from each audio input device 104 (e.g., microphone, line-in cable, etc). Examples of video input devices include web cameras, camcorders, cameras, etc. The video and audio input devices 104 may each be either connected by a cable or wirelessly connected to each computer system 108. The streaming server 118 then synchronizes the received audio streams and distributes a mixed audio stream out to audience members and possibly each musician. In one implementation, the streaming server 118 is also configured to provide video content, based on the received video streams from each musician, to the flash frames presented in the browsers of the users who are participating in the live jam.

In FIG. 1, audience members 120, e.g., 120a and 120b, may receive live audio and video streams from all of the musicians who are participating in a particular jam session. For instance, audience member 120a views the live video stream from one or more musicians (e.g., as shown, a live video of the singer) on display 108d of computer system 106d and listens to a mixed audio stream from all of the musicians from speakers 110d. Likewise, audience member 120b views a live video of the drummer and listens to a mix of the audio streams from the jam session via speakers (not shown) of laptop computer system 106e. Each musician may also view a live video of another musician. As shown, the guitarist 102c views a live video of the singer on display 108c of computer system 106c and may listen to his own audio stream or a mixed audio of all musicians via speakers 110c. Likewise, the singer 102a views a live video of the drummer on display 108a and may listen to an audio stream from the jam session via speakers 110a. Drummer 102b watches live video of the singer while listening to an audio stream from the jam session members via speakers 110b. Alternatively, a metronome may be output from each of the musician's speakers and configured to synchronize the musicians as explained further herein.

Another server for facilitating a jam session may take the form of a chat server 112. The chat server 112 may be configured to manage chat sessions between the audience member, between the jam session members prior to and during the jam, and/or between the audience and jam members. That is, the chat server 112 manages real-time text messaging between participants or viewers of the jam session. Another function of the chat server 112 may include maintaining presence information regarding each chat user and displaying selected presence information to other chat users if they have permission to do so with respect to security settings of the presence information. For example, a particular chat user may select whether the public, a specified private group of friends, or no one is allowed to view her presence information.

A user management and web server 114 may also be utilized to provide web pages for various jam management tasks, such as setting up a jam session, viewing and listening to a jam session, performing in a jam session, etc. The user management and web server 114 may also be configured to archive jam sessions, user information, jam session and participant information, rating and reputation scores, user relationship or security settings, etc., in one or more databases 116.

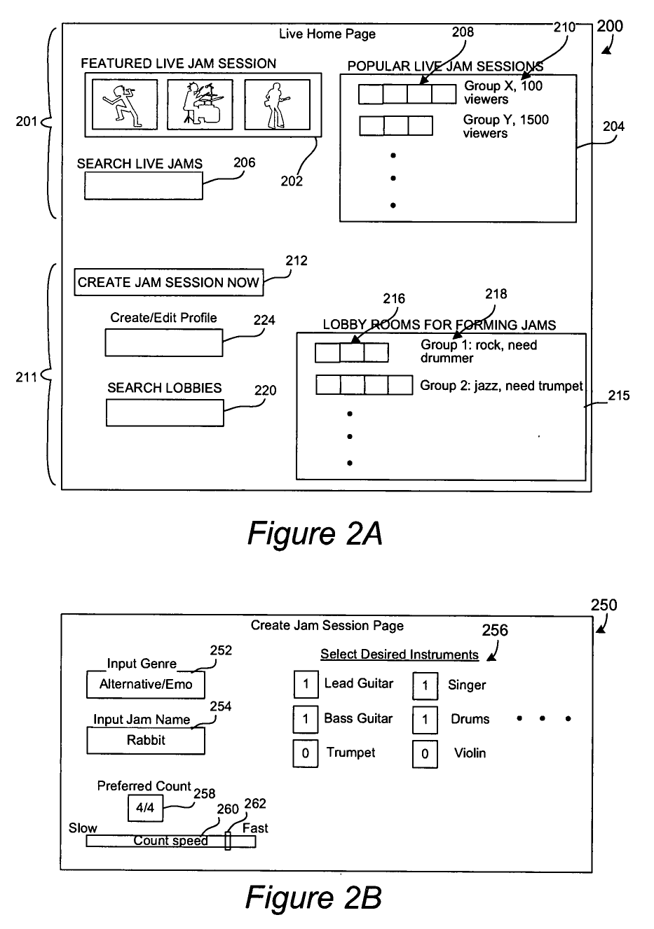

FIG. 2A is a diagrammatic representation of an example graphical user interface 200 for presenting jam session creation and viewing options in accordance with one embodiment of the present invention. For instance, this interface 200 may take the form of a home page for creating or viewing live jam sessions. Each user may enter profile information regarding name, number and type of instruments which they play, music genre preferences, geographic information, etc. Entry of user profile information may be initiated by selection of a “Create/Edit Profile” button 224 so that a user is stepped through a process for entering user information. Alternatively, a user may be presented be allowed to enter user information into fields on the home interface 200.

As shown, the interface 200 may also include a featured jam session 202 that is currently in progress and that a user may view as an audience member. For example, a user may double click on the featured jam session 202 with their mouse or touchpad to view and listen to the featured jam session 202. A list of “POPULAR LIVE JAM SESSIONS” 204 may also be presented to the user for selection. In the current example, a set of live videos 208 and jam session information 210, such as the group name and number of viewers, may also be presented with each popular jam session that is listed.

The interface 200 may also include a mechanism for searching the currently live jam sessions for viewing and listening. In the illustrated embodiment, the user may enter one or more keywords in a “SEARCH LIVE JAMS” input box 206. By way of example, the live jam sessions may be searched by genre, jam session name, number of viewers, jam participant information such as musician names, instrument type and/or number, etc. A list of search results (not shown) may be presented in the interface 200, similar to the list of popular jam sessions 204.

The home interface 200 may also include mechanisms for creating a new jam session or joining a jam session that is being formed. In one example, implementation, the home interface 200 may include a “CREATE JAM SESSION NOW” button 212 for forming a new jam session. There are various interfaces and/or input mechanisms that could be used to allow a user to browse currently forming jam sessions and then joining one of these jam sessions. In the illustrated embodiment, a user may browse a list of “LOBBY ROOMS FOR FORMING JAMS” 215. Each specific lobby room generally serves as a representation of a mechanism for allowing one or more potential jam members to join the corresponding jam session as described further below. Each listed lobby room may include one or more live or recorded videos 216 of current members of such jam session and pertinent information 218 for the currently forming jam session. By way of example, each entry in the lobby room list may specify the jam session name, genre, and a list of the type of instruments that are needed for such jam session. A user may select a particular lobby room, e.g., by double clicking on a particular entry in the “LOBBY ROOMS” list 215. A user may also perform a search for a particular jam session via “SEARCH LOBBIES” input box 220.

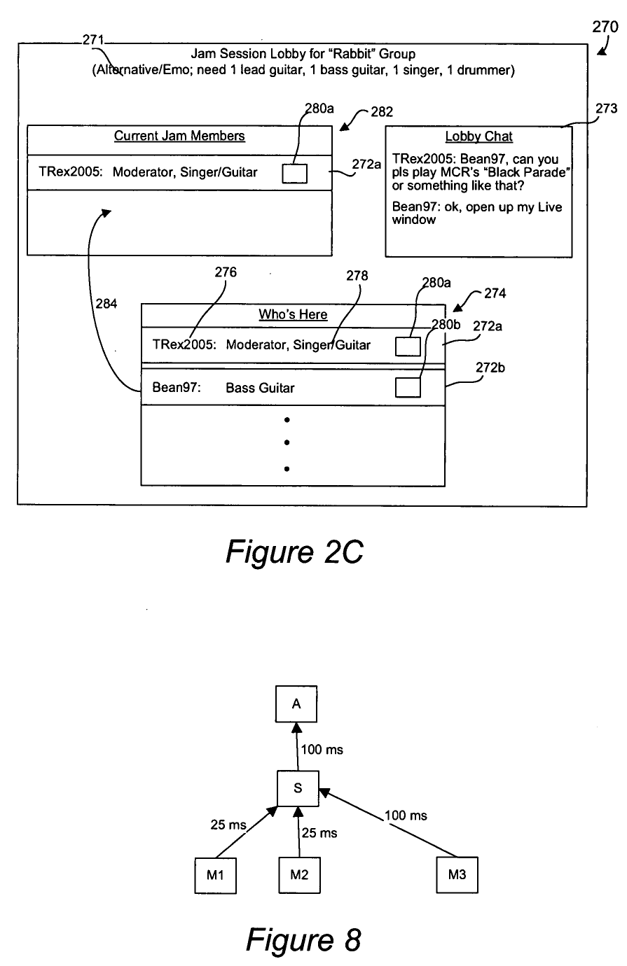

FIG. 3 illustrates flowcharts for creating a jam session in accordance with one embodiment of the present invention. Initially in operation 302, it is determined whether a request to create a new live jam has been received. That is, the following operations may be triggered when a user makes a request to create a new live music collaboration. In the illustrated example, a user selects the “CREATE JAM SESSION NOW” button 212 in the home page 200 of FIG. 2A, and a request to create a new music collaboration is sent from the requesting user's computer system (e.g., 106) to a web server (e.g., 114).

After a request to create a new live jam is received, information for a new live jam session may then be obtained from the requester or moderator in operation 304. Alternatively, information may be received with the request. In the example of FIG. 2A, after the user selected the “CREATE JAM SESSION NOW” button 212 in the home page 200, the user may then be presented with a “Create Jam Session” page. FIG. 2B is a diagrammatic illustration of an interface 250 for creating a new jam session in accordance with one implementation of the present invention. The user can then enter information for the new live jam. For instance, the user can select a genre from a pull-down menu 252, enter a name for the new jam session in the input box 254, and enter counts for the instruments that are needed for the new live jam in one or more input boxes 256. Of course, any other suitable input mechanism, such as pull-down menus, input boxes, checkboxes, multiple input pages, etc., for entering jam information in a computer interface may be utilized. In the example of FIG. 2B, the jam creator has selected the “alternative” music genre category with a “emo” genre subcategory, entered the name “Rabbit” for the new jam; and indicated that 1 lead guitar, 1 bass guitar, 1 drummer, and singer are needed for this “Rabbit” jam session.

Referring back to the jam creation procedure 300 of FIG. 3, the obtained information for the new jam can then added to a list of lobbies for forming jams in operations 306. Additionally, a list of lobbies may then be presented to other users in operation 306. For instance, the new jam session that is now awaiting members to join can now be presented in the list of lobby rooms 215 or a list of search results in the home page 200 of FIG. 2A.

The new lobby is then open for (or presented to) the moderator in operation 308. The new lobby may be open to other potential jam members when such potential members select such the new lobby, e.g., by double clicking on the new jam session in the list of lobby rooms 215. In a specific implementation, the new lobby represents a mechanism for allowing users to join the corresponding jam session.

Any suitable mechanism may be utilized to allow one or more users to join a particular jam session. FIG. 2C is a diagrammatic representation of a lobby interface 270 for allowing one or more users to join a particular jam session in accordance with one embodiment of the present invention. As shown, the lobby interface 270 may include a “Current Jam Members” list 282 that specifies who has joined the jam session. For example, after a particular user requests creation of a specific jam session, he/she can automatically be a member of such jam session and can serve as a moderator for allowing other users to join such jam session. In FIG. 2C, member “TRex2005” is specified as an entry 272a in the “Current Jam Members” list 282, and this entry 272a includes the member name “TRex2005, specifies that he/she is a moderator for such jam session, and may also include a live or recorded video window 280a for the moderator. This live or recorded video window may present a demonstration or demo of the moderator's music capabilities in a audio and video performance that may be selectably viewed.

The lobby interface 270 may also include a “Who's Here” list 274 for indicating the users who have accessed or selected the lobby room for the current jam session. As shown, entry 272b indicates that a second user, besides the moderator “TRex2005”, has entered the lobby room for the “Rabbit” jam session. The lobby interface 270 may also include a lobby chat window 273 for the potential jam members, including the moderator, to chat with each other. Information for the jam session (e.g., 271) that was obtained from the moderator or creator of the jam session may also be displayed in the lobby interface 270.

After a new lobby is opened as illustrated in FIG. 3, it may be determined whether a request from a new potential jam participant to enter the new lobby has been received in operation 310. For example, a user selects the particular jam session from the lobby list 215 of the home page 200 of FIG. 2. If such a request has been received, profile information from the new potential jam participant may also be obtained if not already obtained, e.g., in the home page via the “Create/Edit Profile” button 224, in operation 312. If profile information has not already been obtained, the potential jam member may be walked through a process for entering such profile information. In operation 312, the new lobby (e.g., lobby interface 270) may also be presented to the new participant.

The procedure 300 may also include a flow for determining whether a request to search all available lobbies has been received in operation 301. In the example of FIG. 2A, such a request is received after a user inputs keywords into “SEARCH LOBBIES” box 220. Every time such a request is received, a list of lobbies may be presented to the searcher, e.g., via the LOBBY list 215, based on the searcher's selected search perimeters in operation 303.

Returning to the main flow of FIG. 3, it may also be determined whether a participant is joining the new jam session in operation 314. For instance, the moderator may be allowed to drag and drop a particular participant's entry 272 from the “Who's Here” list 274 to the “Current Jam Members” list 282. As illustrated by arrow 284, entry 272b for participant “Bean97” who plays bass guitar is being dragged to the “Current Jam Members” list 282 so that such musician “Bean97” becomes a jam session member of the “Rabbit” group. In this implementation, the moderator can decide who can join his/her newly created jam session. Alternatively, all of the current members may have to give permission for a specific participant to be added to the jam membership, e.g., by dragging and dropping the specific participant into the “Current Jam Members” list 282 in their respective lobby interfaces 270.

When a participant becomes a new jam member, the jam information 271 may then be updated with information regarding the new jam member in operation 316. It may then be determined whether the jam setup is complete in operation 318. For example, the jam session may be determined to be complete when a jam member is present for each desired instrument. In the present example, the jam session is complete when the current jam members include members who play lead guitar, bass guitar, drums, and sing. Each jam session member may play one or more instruments. For instance, a single jam member may both sing and play lead guitar.

If the jam setup is not complete, the procedure may again check for a request from a new potential jam participant in operation 310 and then check for new jam members in operation 314. When a request from a new potential jam participant is not received (or during any time), it may be also determined whether the new lobby is closed in operation 320. For example, if all participants including the moderator leave a lobby, the lobby may be automatically closed. If the lobby is not closed, the procedure may continue to check for a request from a new potential jam participant and new jam members. Otherwise the new lobby is closed.

After the jam session is completed, a jam session may be automatically initiated. For instance, the jam session members may be presented with a jam session interface immediately after a jam session has its required members so that they can perform together. Alternatively, a predetermined time may be set for later performing the jam session, e.g., as specified by the moderator.

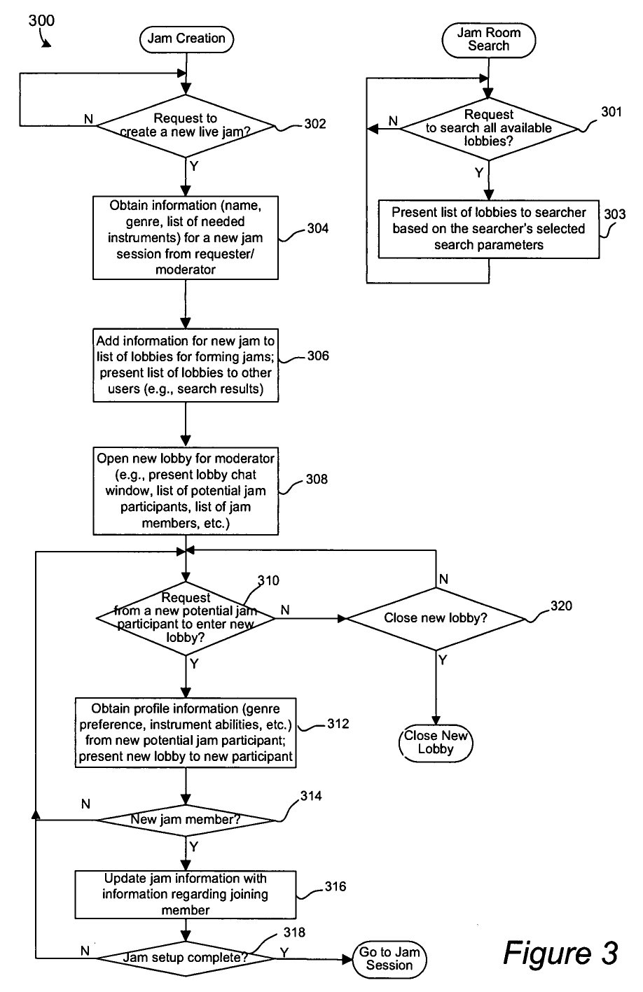

FIG. 4 represents an example interface 400 for facilitating a live jam session in accordance with one embodiment of the present invention. A live jam session interface may be presented to each jam session member, as well as to each audience member. The live jam session interface 400 may include any number of elements. As shown, such interface 400 may include a plurality of live video windows 402a˜c for each jam session member, song information 404, group information 405, and audience information 406.

The song information 404 may include a song title, description of such song or jam session, composer information, etc. The group information 405 may include a name for the current jam session, a list of jam members and their names and/or instrument information, a listing of archived jam session by the same group and/or individual jam members, etc. A link to such archived jam session may also be provided (not shown) or a user may search for archived jam sessions on the home page (not shown).

The audience information 406 may include an audience list 408 which lists the audience members. The list may indicate profile information for each audience member or such profile information may be accessed for a selected audience member. In the illustrated example, when a user selects (e.g., right mouse clicks) a particular audience member, profile information 416 may be displayed. The audience information 406 may also include an audience chat window 412 for allowing the audience members to chat with each other. A live window 410 may also be presented for each audience member or for audience members that allow their live video windows to be presented to all other (or a select number) of audience members.

The audience information 406 may also include a mechanism for each audience member to rate the jam session. As shown, the audience area 406 includes a “clapping” button 420 that may be clicked or selected multiple times by each audience member to indicate such audience member's rating of one or more portions of the jam session. For instance, an audience member may frequently click the “clapping” button 420 multiple times during a portion of the jam session that she particular likes, and not click or less frequently click the “clapping” button during other jam portions that she does not like as much. The frequency at which each audience member selects the “clapping” button 420 may be correlated to a rating score by such each member. The ratings scores from all of the audience members may be collected so that an average rating is determined and presented in the audience information area 406. As shown, an average clap meter 414 is presented.

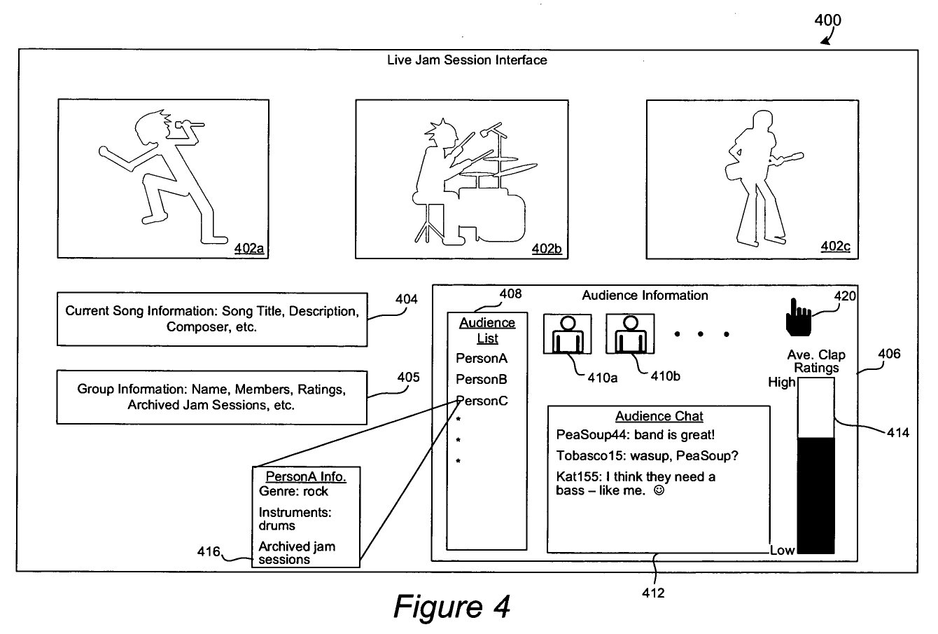

FIG. 5 is a procedure 500 for facilitating a jam session in accordance with one embodiment of the present invention. Initially, song and/or jam information may be presented to each audience and jam session member in operation 502. For example, song information 404 and group information 405 is presented in live jam session interface 400 to each participating jam session member and audience member.

A synchronization process may be performed with jam session members in operation 506 as described further below. Audio and visual streams may be received from each jam session member while adjusting audio input levels in operation 508. For instance, each input level that is received from each jam session member may be adjusted to be at about a same decibel level (or within a predetermined range). There may also be an initial adjustment period in which each jam session member receives feedback so they can adjust their own input levels.

A video stream from each jam session member may be sent to each jam session and audience member in operation 510. The audio streams from all of the jam session members may also be mixed into a mixed audio stream that is sent to each audience member in operation 510. Each jam session member may also receive a mixed audio stream of the other jam session members under certain conditions as described further below.

It may also be determined whether rating input has been received in operation 512. In a specific example, each audience member may rate all or a portion of the live jam session. As rating inputs are received, an average rating of all rating inputs (received so far from audience members) may be determined in operation 514. The determined average rating may also be archived in operation 514. An audience chat window (e.g., (412) may be managed for each audience member in operation 516. Audience information (e.g., 406) may also be sent to each jam and audience member, for example, to receive and output chat text between the audience members, in operation 518. It may be determined whether this jam session has ended in operation 520. If the jam session has not ended, all the operations may be repeated. Otherwise, the procedure 500 for the particular jam session ends.

Any suitable mechanism may be utilized to facilitate ratings or reputation score indications to be input by one or more audience members. Referring to FIG. 4, each audience member may be presented with a rating input interface, such as “clap” button 420, that may be manipulated by the user to specify a rating. In the illustrated example, an audience member may click on the clap button 420 at varied frequencies whenever she likes a particular portion of the jam session. As shown, an average rating 414 may also be presented in the audience information 406 of the jam session interface 400.

The audience member may click the clap button multiple times at a high or lower frequency, and the frequency of selection during each jam session may directly correspond to how much the audience member likes the particular jam session segment. A single average rating for the entire jam session and/or multiple average ratings for various jam session portions may be archived for later viewing, for example, by jam session members or others such as recording executives.

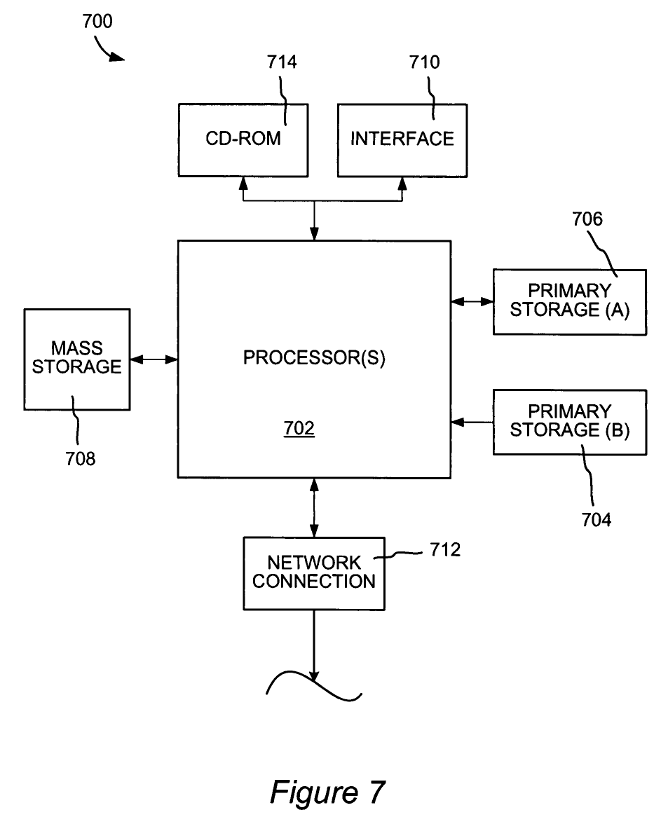

Any suitable synchronization process may be applied to a particular jam session. FIG. 8 is a diagrammatic representation of the latency and/or delays that may be present within a network of remote jam members. As shown, jam session members M1, M2, and M3 each has an associated latency delay (e.g., 25 ms, 25 ms, and 100 ms, respectively) with respect to a server S for receiving the different audio streams from the jam session members. The differences in latency of the different jam session members may make it difficult for each jam session member to hear the combined sound streams from all of the other jam session members and play while hearing other audio streams from other jam members. In one embodiment, each jam member does not receive audio streams from the other jam session members. The audience member, e.g., A, can each receive a mixed audio stream which is delayed by the highest latency value, e.g., 100 ms.

Instead of receiving an audio stream from other jam members, each jam session member may be presented with a metronome count with which the jam session member can play. The metronome counts for the jam session members are substantially identical so that the jam session members can play at a substantially identical beat. The initial jam creation interface may include mechanisms for selecting a particular count, such as 4/4, 3/4, or 7/4 time, and for selecting a count speed. As shown in FIG. 2B, the interface 250 for creating the jam session includes a pull-down menu 458 for selecting the beat or count (e.g., 4/4 time is shown as selected) and a count speed bar 260 for selecting a count speed. As the moderator or jam session creator moves slider 262 along the count speed bar 260, a corresponding metronome count may be audibly played for the creator via the creator's computer system speakers. The creator continues to adjust the slider 262 until the desired speed for the jam session is selected. The resulting metronome can then be played for each of the jam session members in order to synchronize the jam members so that the jam session members can all perform at a substantially same count and speed.

Alternatively, it may be determined whether the latency of each jam session member falls below a predetermined maximum latency. If all of the jam session members have a low enough latency that fall below this predetermined latency (e.g., 5 ms), the jam session members may play together in real-time. In this case, all of the jam session members may receive an initial metronome countdown, e.g., 4-3-2-1, to start the jam session. Each jam member could then receive a mixed audio stream that contains the audio streams from all of the other jam session members. Each jam session member could then experience themselves playing with the other jam session members.

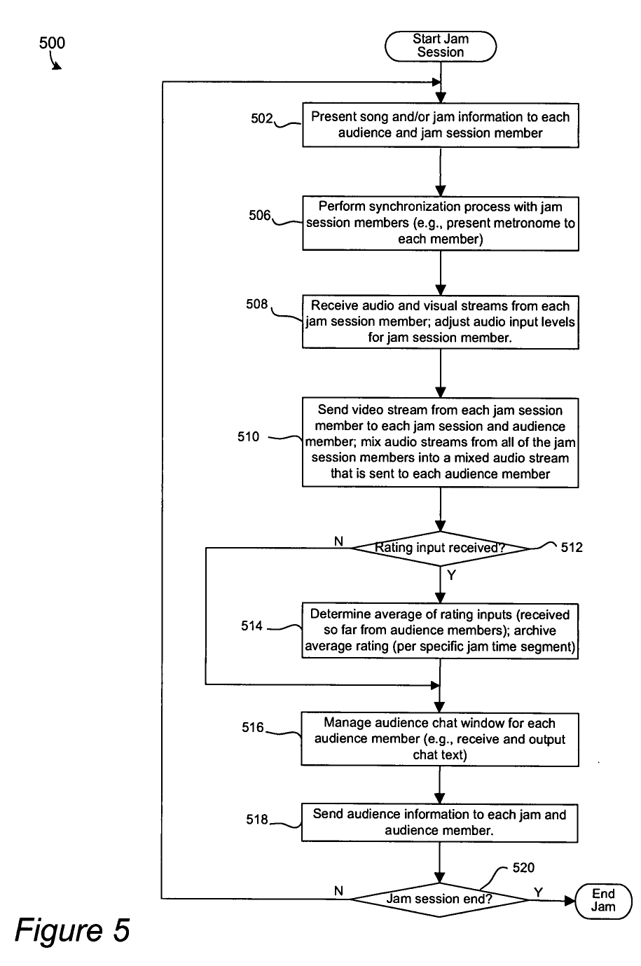

Embodiments of the present invention may be employed to facilitate live jam sessions in any of a wide variety of computing contexts. For example, as illustrated in FIG. 6, implementations are contemplated in which the relevant population of users interact with a diverse network environment via any type of computer (e.g., desktop, laptop, tablet, etc.) 602, media computing platforms 603 (e.g., cable and satellite set top boxes and digital video recorders), handheld computing devices (e.g., PDAs) 604, cell phones 606, or any other type of computing or communication platform.

And according to various embodiments, jam session streams and information that are processed in accordance with the invention may be obtained and/or read using a wide variety of techniques. For example, jam session streams and information representing a user's interaction with a local application, web site or web-based application or service may be accomplished using any of a variety of well known mechanisms for receiving input regarding a user's behavior. However, it should be understood that such methods of collecting live jam session streams and information are merely exemplary and that such information may be collected in many other ways.

Once jam session streams and information have been selected, the session streams and information may be handled according to the invention in some centralized manner. This is represented in FIG. 6 by server 608 and data store 610 that, as will be understood, may correspond to multiple distributed devices and data stores. The invention may also be practiced in a wide variety of network environments (represented by network 612) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

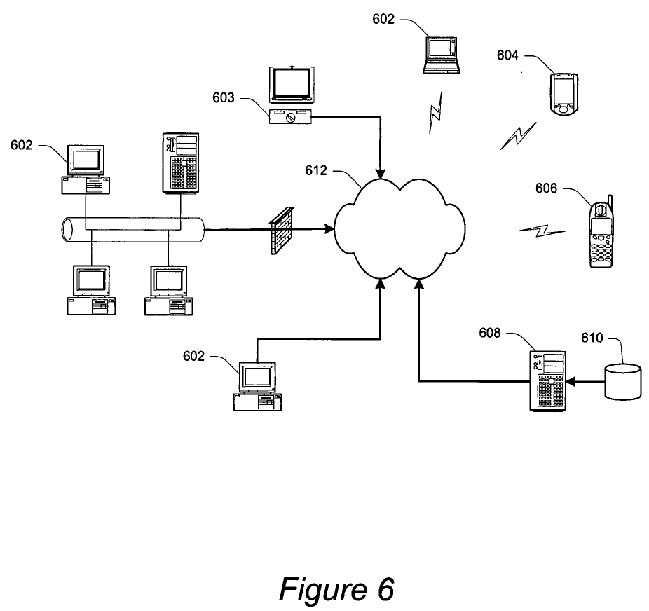

FIG. 7 illustrates a typical computer system that, when appropriately configured or designed, can facilitate various aspects of a live jam session of this invention. The computer system 700 includes any number of processors 702 (also referred to as central processing units, or CPUs) that are coupled to storage devices including primary storage 706 (typically a random access memory, or RAM), primary storage 704 (typically a read only memory, or ROM). CPU 702 may be of various types including microcontrollers and microprocessors such as programmable devices (e.g., CPLDs and FPGAs) and unprogrammable devices such as gate array ASICs or general purpose microprocessors. As is well known in the art, primary storage 704 acts to transfer data and instructions uni-directionally to the CPU and primary storage 706 is used typically to transfer data and instructions in a bi-directional manner. Both of these primary storage devices may include any suitable computer-readable media such as those described herein. A mass storage device 708 is also coupled bi-directionally to CPU 702 and provides additional data storage capacity and may include any of the computer-readable media described above. Mass storage device 708 may be used to store programs, data and the like and is typically a secondary storage medium such as a hard disk. It will be appreciated that the information retained within the mass storage device 708, may, in appropriate cases, be incorporated in standard fashion as part of primary storage 706 as virtual memory. A specific mass storage device such as a CD-ROM 714 may also pass data uni-directionally to the CPU.

CPU 702 is also coupled to an interface 710 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 702 optionally may be coupled to an external device such as a database or a computer or telecommunications network using an external connection as shown generally at 712. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store the jam session audio and/or video streams, audience audio and/or video streams, jam session information, audience information, audience rating information, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave traveling over an appropriate medium such as air, optical lines, electric lines, etc. Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method of facilitating remote collaboration between a plurality of musicians over a computer network, comprising:
when a request to create a new music collaboration session is received from a first musician, obtaining information that includes a specification as to a required number and type of instruments that are needed for the new music collaboration session and making one or more interface(s) for becoming a session member of the new music collaboration session available to each of one or more other musicians who are remotely located with respect to each other and the first musician; and
after enough musicians have become session members of the new music collaboration session, via their respective interfaces, so as to meet the required number and type of musicians, facilitating the execution of the new musical collaboration session so that the session members can perform music together over the computer network.

2. The method as recited in claim 1, further comprising:
each time a request to become a member of the new music collaboration session is received from another musician and until the new music collaboration session includes enough session members to meet the required number and type of musicians, allowing the other musician to become a member of the new music collaboration session if the other musician is permitted to join the new music collaboration session, wherein the other musician is permitted to join the new music collaboration session if the first musician gives permission for the other musician to become a member.

3. The method as recited in claim 1, wherein the one or more interface(s) for becoming a member of the new music collaboration session, that are made available to each of the plurality of musicians, includes a searchable list of lobbies for forming live music jam sessions, which include a lobby for the new music collaboration session, the method further comprising:
when a second musician selects the lobby for the new music collaboration session, presenting the lobby for the new music collaboration session to the second musician, wherein the presented lobby includes (i) a lobby chat window for the second musician to chat with the first musician and other musicians who have also selected the lobby for the new music collaboration, (ii) information from each musician who has also selected the lobby for the new music collaboration, (iii) the specification of the required number and type of musicians that are needed for the new music collaboration session; and
presenting a lobby for the new music collaboration session to the first musician, wherein such lobby includes (i) a lobby chat window for the first musician to chat with the second musician and other musicians who have also selected the lobby for the new music collaboration, (ii) information from each musician who has also selected the lobby for the new music collaboration, and (iii) an input mechanism for allowing the first musician to select one or more musician(s) from the second musician and other musicians, who have also selected the lobby for the new music collaboration, to become members of the new music collaboration.

4. The method as recited in claim 3, wherein the information from each musician includes a live window that can be selected to provide a live or archived audio and/or video feed from such each musician.

5. The method as recited in claim 1, wherein facilitating the execution of the new musical collaboration session is accomplished by:
presenting a session interface to each session member of the new musical collaboration session, wherein the session interface includes a plurality of video windows for streaming live video from the other session members.

6. The method as recited in claim 5, wherein facilitating the execution of the new music collaboration session is further accomplished by:
receiving an audio stream from each session member;
mixing the received audio streams from each session member;
sending the mixed audio streams to a plurality of audience members that have requested to view the new musical collaboration session; and
presenting a session interface to each audience member that includes a plurality of video windows from streaming live video from each session member.

7. The method as recited in claim 6, wherein facilitating the execution of the new music collaboration session is further accomplished by:
adjusting an input level of each received audio stream so as to substantially match the input levels of the received audio streams; and
synchronizing the received audio streams.

8. The method as recited in claim 7, wherein synchronizing the received audio streams in accomplished by providing a same metronome audio and/or visual count to each session member.

9. The method as recited in claim 6, wherein facilitating the execution of the new music collaboration session is further accomplished by:
(a) receiving a rating for the new musical collaboration session from each audience member;
(b) presenting an average rating, based on the rating from each audience member, in each session interface that is presented to each session and audience member; and
(c) archiving the new music collaboration session and the rating in a database that is accessible by one or more users.

10. The method as recited in claim 9, wherein multiple ratings are received for a plurality of time segments of the new music collaboration session and an average rating is determined and archived for each time segment.

11. An apparatus for facilitating remote collaboration between a plurality of musicians over a computer network, comprising at least a processor and a memory, wherein the processor and/or memory are configured to perform the following operations:
when a request to create a new music collaboration session is received from a first musician, obtaining information that includes a specification as to a required number and type of instruments that are needed for the new music collaboration session and making one or more interface(s) for becoming a session member of the new music collaboration session available to each of one or more other musicians who are remotely located with respect to each other and the first musician; and
after enough musicians have become session members of the new music collaboration session, via their respective interfaces, so as to meet the required number and type of musicians, facilitating the execution of the new musical collaboration session so that the session members can perform music together over the computer network.

12. The apparatus as recited in claim 11, wherein the processor and/or memory are further configured to:
each time a request to become a member of the new music collaboration session is received from another musician and until the new music collaboration session includes enough session members to meet the required number and type of musicians, allowing the other musician to become a member of the new music collaboration session if the other musician is permitted to join the new music collaboration session, wherein the other musician is permitted to join the new music collaboration session if the first musician gives permission for the other musician to become a member.

13. The apparatus as recited in claim 11, wherein the one or more interface(s) for becoming a member of the new music collaboration session, that are made available to each of the plurality of musicians, includes a searchable list of lobbies for forming live music jam sessions, which include a lobby for the new music collaboration session, wherein the processor and/or memory are further configured to:
when a second musician selects the lobby for the new music collaboration session, presenting the lobby for the new music collaboration session to the second musician, wherein the presented lobby includes (i) a lobby chat window for the second musician to chat with the first musician and other musicians who have also selected the lobby for the new music collaboration, (ii) information from each musician who has also selected the lobby for the new music collaboration, (iii) the specification of the required number and type of musicians that are needed for the new music collaboration session; and
presenting a lobby for the new music collaboration session to the first musician, wherein such lobby includes (i) a lobby chat window for the first musician to chat with the second musician and other musicians who have also selected the lobby for the new music collaboration, (ii) information from each musician who has also selected the lobby for the new music collaboration, and (iii) an input mechanism for allowing the first musician to select one or more musician(s) from the second musician and other musicians, who have also selected the lobby for the new music collaboration, to become members of the new music collaboration.

14. The apparatus as recited in claim 13, wherein the information from each musician includes a live window that can be selected to provide a live or archived audio and/or video feed from such each musician.

15. The apparatus as recited in claim 11, wherein facilitating the execution of the new musical collaboration session is accomplished by:
presenting a session interface to each session member of the new musical collaboration session, wherein the session interface includes a plurality of video windows for streaming live video from the other session members.

16. The apparatus as recited in claim 15, wherein facilitating the execution of the new music collaboration session is further accomplished by:
receiving an audio stream from each session member;
mixing the received audio streams from each session member;
sending the mixed audio streams to a plurality of audience members that have requested to view the new musical collaboration session; and
presenting a session interface to each audience member that includes a plurality of video windows from streaming live video from each session member.

17. The apparatus as recited in claim 16, wherein facilitating the execution of the new music collaboration session is further accomplished by:
adjusting an input level of each received audio stream so as to substantially match the input levels of the received audio streams; and
synchronizing the received audio streams.

18. The apparatus as recited in claim 17, wherein synchronizing the received audio streams in accomplished by providing a same metronome audio and/or visual count to each session member.

19. The apparatus as recited in claim 16, wherein facilitating the execution of the new music collaboration session is further accomplished by:
(a) receiving a rating for the new musical collaboration session from each audience member;
(b) presenting an average rating, based on the rating from each audience member, in each session interface that is presented to each session and audience member; and
(c) archiving the new music collaboration session and the rating in a database that is accessible by one or more users.

20. The apparatus as recited in claim 19, wherein multiple ratings are received for a plurality of time segments of the new music collaboration session and an average rating is determined and archived for each time segment.

21. At least one computer readable storage medium having computer program instructions stored thereon that are arranged to perform the following operations:
when a request to create a new music collaboration session is received from a first musician, obtaining information that includes a specification as to a required number and type of instruments that are needed for the new music collaboration session and making one or more interface(s) for becoming a session member of the new music collaboration session available to each of one or more other musicians who are remotely located with respect to each other and the first musician; and
after enough musicians have become session members of the new music collaboration session, via their respective interfaces, so as to meet the required number and type of musicians, facilitating the execution of the new musical collaboration session so that the session members can perform music together over the computer network.

22. The at least one computer readable storage medium of claim 21, wherein the one or more interface(s) for becoming a member of the new music collaboration session, that are made available to each of the plurality of musicians, includes a searchable list of lobbies for forming live music jam sessions, which include a lobby for the new music collaboration session, the method further comprising:
when a second musician selects the lobby for the new music collaboration session, presenting the lobby for the new music collaboration session to the second musician, wherein the presented lobby includes (i) a lobby chat window for the second musician to chat with the first musician and other musicians who have also selected the lobby for the new music collaboration, (ii) information from each musician who has also selected the lobby for the new music collaboration, (iii) the specification of the required number and type of musicians that are needed for the new music collaboration session; and
presenting a lobby for the new music collaboration session to the first musician, wherein such lobby includes (i) a lobby chat window for the first musician to chat with the second musician and other musicians who have also selected the lobby for the new music collaboration, (ii) information from each musician who has also selected the lobby for the new music collaboration, and (iii) an input mechanism for allowing the first musician to select one or more musician(s) from the second musician and other musicians, who have also selected the lobby for the new music collaboration, to become members of the new music collaboration,
wherein the information from each musician includes a live window that can be selected to provide a live or archived audio and/or video feed from such each musician.

23. The at least one computer readable storage medium of claim 1, wherein facilitating the execution of the new musical collaboration session is accomplished by:
presenting a session interface to each session member of the new musical collaboration session, wherein the session interface includes a plurality of video windows for streaming live video from the other session members.
receiving an audio stream from each session member;
mixing the received audio streams from each session member;
sending the mixed audio streams to a plurality of audience members that have requested to view the new musical collaboration session; and
presenting a session interface to each audience member that includes a plurality of video windows from streaming live video from each session member.

24. The at least one computer readable storage medium of claim 6, wherein facilitating the execution of the new music collaboration session is further accomplished by:
adjusting an input level of each received audio stream so as to substantially match the input levels of the received audio streams; and
synchronizing the received audio streams,
wherein synchronizing the received audio streams in accomplished by providing a same metronome audio and/or visual count to each session member.

25. The at least one computer readable storage medium of claim 6, wherein facilitating the execution of the new music collaboration session is further accomplished by:
(a) receiving a rating for the new musical collaboration session from each audience member;
(b) presenting an average rating, based on the rating from each audience member, in each session interface that is presented to each session and audience member; and
(c) archiving the new music collaboration session and the rating in a database that is accessible by one or more users,
wherein multiple ratings are received for a plurality of time segments of the new music collaboration session and an average rating is determined and archived for each time segment.
